(19) United States
(12) Patent Application Publication
(10) Pub. No.: US 2019/0073692 A1
(43) Pub. Date: Mar. 7, 2019

(54) IDENTIFYING AN ASSOCIATION AMONG USER-IDENTIFYING INFORMATION MAINTAINED IN A THIRD-PARTY SYSTEM FOR A USER OF AN ONLINE SYSTEM

(71) Applicant: Facebook, Inc., Menlo Park, CA (US)

(72) Inventors: Sanjay Kanaka Sai Tirupattur Saravanan, Fremont, CA (US); Katherine Hoffmann, San Francisco, CA (US)

(21) Appl. No.: 15/694,703

(22) Filed: Sep. 1, 2017

(51) Int. Cl. G06Q 30/02; G06F 21/62

(52) U.S. Cl. CPC G06Q 30/0255; G06Q 30/0269; G06F 21/6254

(57) ABSTRACT

An online system receives user-identifying information for an online system user when a request associated with a content item is received from the user at a content publisher. The online system compares this information to user-identifying information maintained in the online system for online system users and adds the received information to user-identifying information maintained in the online system for a user upon finding a match. The online system communicates information describing an association among user-identifying information maintained in the online system and in a partnering third-party system for the user to a trusted third-party system. The trusted third-party system compiles a report based at least in part on this information and information describing requests associated with content items received at content publishers from online system users. The trusted third-party system may aggregate information received from multiple identity providers and resolve inconsistencies among this information by applying various rules.

### BACKGROUND

This disclosure relates generally to online systems, and more specifically to identifying an association among user-identifying information maintained in a third-party system for a user of an online system.

An online system allows its users to connect and communicate with other online system users. Users create profiles in the online system that are tied to their identities and include information about the users, such as interests and demographic information. The users may be individuals or entities such as corporations or charities. Because of the popularity of online systems and the significant amount of user-specific information maintained in online systems, an online system provides an ideal forum for users to share content by creating content items for presentation to additional online system users. For example, users may share photos or videos they have uploaded to an online system by creating content items that include the photos or videos, which are then presented to additional users to whom they are connected in the online system. An online system also provides abundant opportunities to persuade online system users to take various actions and/or to increase awareness about products, services, opinions, or causes among online system users by allowing users to provide content items (e.g., advertisements) for presentation to online system users. For example, an advertiser may provide an advertisement to an online system for presentation to online system users that encourages the users to purchase a product associated with the advertisement.

Conventionally, online systems generate revenue by displaying content items, such as advertisements, to their users. For example, an online system may charge advertisers for each presentation of an advertisement to an online system user (i.e., each “impression”), or for each interaction with an advertisement by an online system user. Furthermore, by presenting content items that encourage user engagement with online systems, online systems may increase the number of opportunities they have to generate revenue. For example, if a user scrolls through a newsfeed to view content items that capture their interest, advertisements that are interspersed in the newsfeed may be presented to the user. Therefore, online systems may derive an economic benefit from presenting content items created or provided by online system users.

To encourage users of an online system (e.g., advertisers) to create and/or to provide content items (e.g., advertisements) for presentation to other online system users, an online system may offer to collect information describing the performance of content items presented by the online system and to determine various performance metrics for the content items based on this information. For example, an online system may track presentations of a content item by the online system to its users and purchases made by the users in association with presentations of the content item. In this example, the online system may determine performance metrics for the content item, which may describe a number of online system users who were presented with the content item by the online system during a specific time period and a percentage of those users who made a purchase in association with being presented with the content item. Once an online system has determined one or more performance metrics for a content item, the online system may communicate these performance metrics to a user of the online system from whom the content item was received, allowing the user to evaluate the success of the content item among users presented with the content item by the online system.

Content items created or provided by users of an online system (“content providers”) for presentation to additional users of the online system also may be provided to multiple content publishers, which may present the content items to online system users outside of the online system. Third-party measurement systems may offer to determine performance metrics for content items presented to online system users outside of the online system by collecting information describing the performance of content items presented by these content publishers. A third-party measurement system may collect information describing the performance of a content item using a tracking mechanism (e.g., a tag or a cookie). For example, a third-party measurement system may add a tag to a content item, which is configured to communicate information describing a request associated with the content item to the third-party system upon receiving the request at a content publisher. In this example, information describing the request may include information identifying the content item, information describing the type of request, an IP address associated with a client device from which the request was received, and a time the request was received. Alternatively, in the above example, the third-party measurement system may set a cookie in the client device and retrieve information describing the request associated with the content item via the cookie upon receiving the request at the content publisher.

However, the use of tracking mechanisms may make it difficult to collect complete and accurate information describing the performance of content items. For example, suppose that a content item is provided to multiple content publishers and that a different third-party measurement system is used to determine performance metrics for the content item presented by each content publisher. In this example, if each third-party measurement system requires their own tag to be added to a content item in order to track its performance, multiple tags may have to be added to the same content item, increasing the likelihood that problems with collecting comprehensive information describing the performance of the content item will arise (e.g., if the content provider forgets to add a tag or if a tag is configured improperly). Furthermore, online system users may delete cookies stored in their client devices by third-party measurement systems, making it difficult for third-party measurement systems to accurately track the performance of content items.

Additionally, online system users may use multiple client devices to view or to perform interactions with the same content items presented by different content publishers, making it even more difficult for third-party measurement systems to accurately track the performance of content items. For example, suppose that an online system user is presented with a content item several times by a first content publisher via a mobile device and later clicks on the content item when it is presented by a second content publisher via a laptop computer. In this example, performance metrics for the content item may fail to indicate that the user clicked on the content item after being presented with the content item several times if performance metrics for the first and second content publisher are generated by different third-party measurement systems.

To provide content providers with more accurate and more comprehensive information describing the performance of content items across different content publishers and across different client devices, third-party measurement systems may share information that they have collected with each other and with the online system. However, this may raise privacy concerns among content providers who may not want this information to be shared, which may deter content providers from taking advantage of performance tracking services. Furthermore, failure to integrate information describing the performance of content items across different client devices and content publishers may cause content providers to receive inaccurate and/or incomplete performance metrics, which may discourage them from creating and/or from providing content items for presentation to other online system users.

### SUMMARY

An online system presents content items (e.g., advertisements) to users of the online system and maintains user-identifying information for the users. User-identifying information for a user may include personally identifiable information that may be used to identify an individual, such as a full name, a home address, a phone number, an email address, a user identifier that is unique to the individual in the online system or in a third-party system (e.g., a username, a user identification number, or a cookie identifier), a client device identifier (e.g., an IP address), a browser identifier (e.g., a user agent), etc. In some embodiments, user-identifying information also may include additional types of information that potentially may be combined with other personal information to identify an individual, such as an age, a gender, a geographic region, etc.

In some embodiments, user-identifying information maintained in the online system may be generated and/or assigned by the online system. For example, when a user of the online system requests to access a page maintained in the online system, the online system may determine whether the request includes a cookie identifier that is unique to the user in the online system. In this example, if the request does not include a cookie identifier that is unique to the user in the online system, the online system may set a cookie in a client device from which the request was received by generating a cookie identifier that is unique to the user in the online system and by storing it in the client device and in the online system in association with a user profile of the user. Continuing with this example, if the online system subsequently receives an additional request from the user to access another page maintained in the online system, the request may include the cookie identifier, allowing the user to be identified by the online system.

User-identifying information maintained in the online system may be received from users of the online system. For example, when the online system receives a request from a prospective user of the online system to create a user account, the online system may require the prospective user to provide user-identifying information such as a first name, a last name, and an email address. In this example, the online system also may request that the prospective user provide optional user-identifying information such as a profile picture, a phone number, a birthdate, a geographic location, an occupation, hobbies/interests, etc. Continuing with this example, upon receiving the user-identifying information, the online system may store it in association with a user profile of the user maintained in the online system. As an additional example, upon receiving a request from a user of the online system to access a page maintained in the online system, the online system may receive user-identifying information (e.g., a cookie identifier, an IP address, a browser identifier, etc.) stored in a cookie in a client device from which the request was received.

The online system also may receive user-identifying information from various “partnering third-party systems” (e.g., third-party measurement systems that offer performance tracking services for content items presented by one or more content publishers with which the online system has formed partnerships). For example, the online system may receive various types of user-identifying information for an online system user from a partnering third-party system, such as the user's name and home address and a user identification number that is unique to the user in the partnering third-party system. In some embodiments, personally identifiable information associated with online system users received from a partnering third-party system may be obfuscated. For example, personally identifiable information may be encrypted using a cryptographic hash function that creates hashes of the personally identifiable information. In some embodiments, the online system may store user-identifying information in association with information describing its receipt (e.g., when, how, and from whom it was received). For example, the online system may store an IP address associated with an online system user in association with a date and a time that it was received and information indicating that the IP address was received from a partnering third-party system.

In various embodiments, the online system may receive user-identifying information for a user of the online system in response to the receipt of a request associated with a content item from the user at a content publisher. For example, the online system may receive a browser identifier and a cookie identifier associated with an online system user when a content publisher receives a request associated with a content item from the user. Examples of requests associated with a content item include a request to present the content item, a request to perform an action associated with the content item (e.g., a request to make a purchase associated with the content item or a request to share the content item with additional online system users), a request to access additional content associated with the content item, a request to check-in to a physical location associated with the content item, etc. In various embodiments, the online system may act as a content provider. Furthermore, in some embodiments, the online system may receive user-identifying information for an online system user in response to the receipt of a request associated with a content item at a content publisher via a cookie stored in a client device associated with the user. For example, if the online system is a content publisher and receives a request to present a content item to an online system user via a client device, the online system may receive user-identifying information for the user in conjunction with the request via a cookie previously stored in the client device by the online system.

In some embodiments, the online system also may receive user-identifying information in response to the receipt of a request associated with a content item at a content publisher via a “partner tag” added to the content item by a partnering third-party system. A partner tag that is added to a content item may be configured to communicate information describing a request associated with the content item to a partnering third-party system that added the partner tag to the content item, which the partnering third-party system may then communicate to the online system. Information describing a request associated with a content item may include user-identifying information for a user of the online system from whom the request was received, information identifying the content item associated with the request, information describing a type of request received at a content publisher (e.g., to present the content item, to perform an action associated with the content item, etc.), a date/time of the request, etc. For example, suppose that a partnering third-party system adds a partner tag to a content item and provides the content item to a content publisher. In this example, if the content publisher presents the content item to an online system user who then clicks on the content item, the partnering third-party system may receive user-identifying information for the user, information identifying the content item, information indicating that the user clicked on the content item, and information indicating a time at which the user clicked on the content item. Continuing with this example, the partnering third-party system may then forward some or all of this information to the online system.

A partner tag also may be configured to redirect information describing a request associated with a content item to the online system when a content publisher receives the request associated with the content item. For example, suppose that a partner tag that is added to a content item by a partnering third-party system is configured to redirect information describing a request associated with the content item to the partnering third-party system and to the online system. In this example, upon receipt of a request associated with the content item at a content publisher, the partner tag may instruct a browser on a client device from which the request was received to communicate information describing the request to the online system.

In some embodiments, user-identifying information that is communicated to a partnering third-party system may not include user-identifying information that is unique to an online system user in the online system, such that this information is maintained exclusively in the online system. Examples of user-identifying information that may be maintained exclusively in the online system include a cookie identifier, a username, or a user identification number that is unique to a user in the online system. For example, suppose that a cookie identifier that is unique to an online system user in a partnering third-party system and an additional cookie identifier that is unique to the online system user in the online system are stored in a client device associated with the online system user. In this example, suppose also that a partner tag is added to a content item by a partnering third-party system. Continuing with this example, if a content publisher receives a request to present the content item from the client device, information describing the request that is communicated to the partnering third-party system via the partner tag may include the cookie identifier that is unique to the user in the partnering third-party system, but may not include the cookie identifier that is unique to the user in the online system.

Information describing requests associated with content items received at content publishers from users of the online system also may be communicated to a trusted neutral third-party system (“trusted third-party system”). For example, when a partnering third-party system receives information describing a request to present a content item to an online system user at a content publisher (e.g., via a partner tag), the partnering third-party system may communicate information describing the request to a trusted third-party system. Alternatively, in the above example, information describing the request may be communicated to the trusted third-party system by the online system, which receives the information from the partnering third-party system or via a partner tag. As another alternative to the above examples, the information describing the request may be communicated to the trusted third-party system via a partner tag configured to redirect information describing the request associated with the content item to the trusted third-party system when the content publisher receives the request associated with the content item.

Once the online system has received user-identifying information, the online system may compare this information to user-identifying information of the same type maintained in the online system for various online system users. For example, if the online system receives a cookie identifier that is unique to a user in the online system in conjunction with a cookie identifier that is unique to the user in a partnering third-party system, the online system may compare the cookie identifiers to cookie identifiers of the same type maintained in the online system for various online system users. In embodiments in which user-identifying information received at the online system is obfuscated, the online system may compare the obfuscated information to information maintained in the online system that is similarly obfuscated. In the above example, if the cookie identifiers received at the online system are encrypted using a cryptographic hash function, the online system may create hashes of the cookie identifiers maintained in the online system using the same cryptographic hash function and compare the hashes of the cookie identifiers.

In some embodiments, to compare user-identifying information received at the online system to user-identifying information maintained in the online system for various online system users, the online system may identify various types of user-identifying information included in the received information and/or included in user-identifying information maintained in the online system. Examples of types of user-identifying information include first and last names, IP addresses, cookie identifiers, email addresses, phone numbers, etc. For example, the online system may determine if user-identifying information received at the online system includes an IP address based on whether any of the information is in a format that characterizes IP addresses written in IPv4 notation or IPv6 notation. As an additional example, the online system may identify user-identifying information maintained in the online system corresponding to an email address based on whether at least some of the format of the user-identifying information conforms to the format of an email address (i.e., a string having a local part and a domain separated by an @ symbol). In some embodiments, the online system also may identify various types of user-identifying information maintained in the online system based on information stored in association with user profiles of various online system users. For example, the online system may access a user profile maintained in the online system for a user of the online system and identify a username as a username that is unique to the user in a partnering third-party system as opposed to a username that is unique to the user in the online system based on information stored in association with the username indicating that the username was received from the partnering third-party system.

Based on whether any user-identifying information received at the online system matches any user-identifying information of the same type maintained in the online system for a particular user, the online system may add the received information to the user-identifying information maintained in the online system for that user, creating a combined set of user-identifying information maintained in the online system for the user. For example, suppose that the online system receives a first cookie identifier in conjunction with a second cookie identifier, in which the first cookie identifier is unique to an online system user in the online system and the second cookie identifier is unique to the user in a partnering third-party system. In this example, if the first cookie identifier matches a cookie identifier that is unique to the user in the online system included among user-identifying information maintained in the online system for the user, the online system may add the second cookie identifier to the user-identifying information maintained in the online system for the user, creating a combined set of user-identifying information for the user that is maintained in the online system.

In some embodiments, user-identifying information received at the online system may match user-identifying information of the same type maintained in the online system for multiple users. In one embodiment, the online system may create a combined set of user-identifying information maintained in the online system for each user having user-identifying information that matches the user-identifying information received at the online system by adding the received information to the user-identifying information maintained in the online system for each user. In an alternative embodiment, the online system may discard user-identifying information received at the online system that matches user-identifying information maintained in the online system for multiple online system users.

In various embodiments, if user-identifying information received at the online system does not match user-identifying information maintained in the online system for any online system users, the online system may store this “unmatched user-identifying information.” For example, if the online system receives an IP address associated with a client device in conjunction with a cookie identifier that is unique to an individual in a partnering third-party system, the online system may compare the IP address and the cookie identifier to IP addresses and cookie identifiers maintained in the online system for various online system users. In this example, if neither the IP address nor the cookie identifier received at the online system matches an IP address or a cookie identifier maintained in the online system for an online system user, the online system may store the IP address in association with the cookie identifier for later retrieval (e.g., among a set of additional user-identifying information maintained in the online system that is not associated with any particular user of the online system). In alternative embodiments, the online system may discard unmatched user-identifying information.

In embodiments in which the online system stores unmatched user-identifying information, the online system may later compare this information to user-identifying information maintained in the online system for various online system users (e.g., periodically or after user-identifying information has been added to user-identifying information maintained in the online system, as described below). The online system may then create a combined set of user-identifying information based on the comparison. For example, if the online system determines that previously unmatched user-identifying information matches user-identifying information maintained in the online system for a user of the online system, the online system may create a combined set of user-identifying information for that user by adding the previously unmatched user-identifying information to user-identifying information maintained in the online system for that user.

The online system may identify a set of user-identifying information that is maintained in the online system and in a partnering third-party system for the same online system user. For example, suppose that a cookie identifier and a username that are unique to an online system user in a partnering third-party system are added to user-identifying information maintained in the online system for the user, creating a combined set of user-identifying information for the user that is maintained in the online system. In this example, the online system may identify the cookie identifier and the username as user-identifying information that is maintained in the online system and in the partnering third-party system for the same user since the cookie identifier and the username are unique to the user in the partnering third-party system. In the above example, if the user-identifying information maintained in the online system for the user also includes a cookie identifier that is unique to the user in the online system, the online system may not identify the cookie identifier as user-identifying information that is maintained in the online system and in the partnering third-party system for the same user since it is maintained only in the online system.

Once the online system has identified a set of user-identifying information that is maintained in the online system and in a partnering third-party system for the same online system user, the online system may act as an identity provider by communicating information describing an association among this set of user-identifying information to a trusted third-party system. The information describing the association among the set of user-identifying information may indicate that the information is associated with the same online system user. For example, the online system may communicate information to a trusted neutral server that describes an association between a cookie identifier that is unique to a user in a partnering third-party system and a user identification number assigned to the same user by the partnering third-party system.

The trusted third-party system may compile a report based at least in part on information describing an association among a set of user-identifying information for one or more online system users and information describing requests associated with content items received at various content publishers from these users. The report may include various analytics that describe one or more performance metrics for one or more content items presented to online system users by one or more content publishers. Examples of performance metrics include impression performance metrics, revenue performance metrics, interaction performance metrics, etc. For example, the trusted third-party system may compute impression performance metrics and revenue performance metrics for a content item based on information describing impressions and conversions achieved by the content item when presented to online system users by different content publishers. In this example, the trusted third-party system may then generate various analytics describing the performance metrics and compile the analytics into a report.

In some embodiments, the trusted third-party system may compile the report by determining a sequence of events associated with a content item based on information describing multiple requests associated with the content item received from an online system user. For example, the trusted third-party system may receive information from a partnering third-party system describing a request to present a content item at a first content publisher received from an online system user associated with a first cookie identifier and a second request to access additional content associated with the same content item subsequently received at a second content publisher from an online system user associated with a second cookie identifier. In this example, if information received from the online system indicates that the first cookie identifier and the second cookie identifier are associated with the same online system user, the trusted third-party system may determine that the user requested to access additional content associated with the content item at the second content publisher after being presented with the content item by the first content publisher and compile a report based on this determination. In various embodiments, the report may be compiled by multiple trusted third-party systems. In the above example, a first trusted third-party system may determine the sequence of events and then communicate information describing the sequence of events to a second trusted third-party system that generates the analytics associated with the content item based on the sequence of events and compiles them into the report.

In some embodiments, the trusted third-party system also may compile the report based on information received from identity providers other than the online system. In such embodiments, the trusted third-party system may aggregate the information received from multiple identity providers prior to compiling the report. For example, the trusted third-party-system may receive information from a first identity provider indicating that a username that is unique to a user in a partnering third-party system is associated with a client device identifier and information from a second identity provider indicating that a cookie identifier that is unique to a user in a partnering third-party system is associated with the same client device identifier. In this example, the trusted third-party system may aggregate the information received from the first and second identity providers, such that the username, the client device identifier, and the cookie identifier are associated with the same online system user. Continuing with this example, if the trusted third-party system receives information describing requests associated with content items received from a user of the online system associated with the username, the cookie identifier, and/or the client device identifier, the trusted third-party system may determine that the requests are attributable to the same online system user and compile a report based on this determination.

In embodiments in which the trusted third-party system receives information describing associations among sets of user-identifying information from multiple identity providers, the information received from different identity providers may be inconsistent. For example, the trusted third-party system may receive information from a first identity provider indicating that a cookie identifier that is unique to an online system user in a partnering third-party system is associated with a client device identifier. In this example, the trusted third-party system also may receive information from a second identity provider indicating that the cookie identifier is associated with a different client device identifier, such that information received at the trusted third-party system from the first and second identity providers are inconsistent.

In various embodiments, the trusted third-party system may resolve inconsistencies among information describing associations among sets of user-identifying information provided by different identity providers by applying various rules. In some embodiments, a rule applied by the trusted third-party system may be based on different priorities associated with different identity providers. For example, a rule may specify a ranking of different identity providers based on different priorities associated with the identity providers, such that if inconsistent information is provided to the trusted-third-party system by different identity providers, the information provided by the highest ranked identity provider (i.e., the identity provider having the highest priority) is used to compile a report. In embodiments in which different identity providers are associated with different priorities, inconsistencies among the information may be resolved dynamically depending on the identity providers that provided the inconsistent information. In some embodiments, rules applied by the trusted third-party system to resolve inconsistencies among information received from different identity providers may be specified by a partnering third-party system. For example, the trusted third-party system may receive various rules from different partnering third-party systems, such that if inconsistent information includes information describing associations among sets of user-identifying information that are maintained in a partnering third-party system, the trusted third-party system may apply one or more rules received from the partnering third-party system to resolve the inconsistency.

The trusted third-party system also may resolve inconsistencies among information provided by different identity providers by computing a score associated with information provided by each identity provider. The score associated with information provided by an identity provider may be computed by the trusted third-party system based on a model maintained in a partnering third-party system. For example, a model maintained in a partnering third-party system may specify a weight associated with information provided by an identity provider based on a priority associated with the identity provider, the type of information provided, a time that the information was provided, etc. Based on the score associated with the information provided by each identity provider, the trusted third-party system may resolve inconsistencies among the information (e.g., by using information associated with the highest scores to compile the report).

The report compiled by the trusted third-party system may be communicated by the trusted third-party system to a partnering third-party system, to a content publisher, or to a content provider (e.g., an advertiser). For example, if the trusted third-party system compiles a report based on user-identifying information that is maintained in a partnering third-party system, the trusted third-party system may communicate the report to the partnering third-party system. In this example, if the report compiled by the trusted third-party system includes various analytics for a content item, the report also may be communicated to a content provider associated with the content item. Additionally, in this example, if the report includes analytics describing the presentation of the content item by a content publisher, the report also may be communicated to the content publisher.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an interaction diagram of a method for identifying an association among user-identifying information maintained in a third-party system for a user of an online system, in accordance with an embodiment.

FIG. 4 is a conceptual diagram of identifying an association among user-identifying information maintained in a third-party system for a user of an online system and communicating the association to a trusted third-party system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

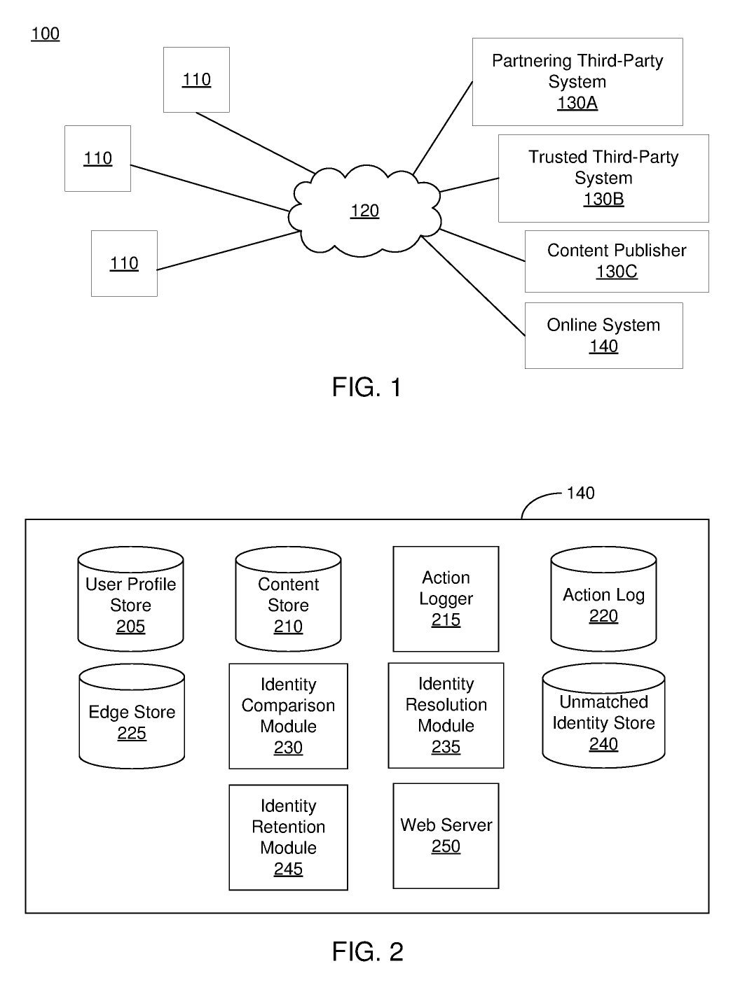

FIG. 1 is a block diagram of a system environment 100 for an online system 140. The system environment 100 shown by FIG. 1 comprises one or more client devices 110, a network 120, one or more third-party systems 130 (e.g., one or more partnering third-party systems 130A, one or more trusted third-party systems 130B, and one or more content publishers 130C), and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 (e.g., a content publisher 130C) provides content or other information for presentation via a client device 110. A third-party system 130 also may communicate information to the online system 140, such as advertisements, content, or information about an application provided by the third-party system 130.

Partnering third-party systems 130A are third-party systems 130 with which the online system 140 has formed partnerships (e.g., third-party measurement systems that offer performance tracking services for content items presented by one or more content publishers 130C). The online system 140 may receive user-identifying information for users of the online system 140 from a partnering third-party system 130A. User-identifying information may include personally identifiable information that may be used to identify an individual. Examples of personally identifiable information may include an individual's full name, home address, phone number, email address, etc. As an additional example, personally identifiable information may include a user identifier that is unique to an individual in the online system 140 or in a partnering third-party system 130A (e.g., a username, a user identification number, or a cookie identifier), a client device identifier (e.g., an IP address) or a browser identifier (e.g., a user agent) associated with an individual, etc. In embodiments in which user-identifying information received from a partnering third-party system 130A includes personally identifiable information, the personally identifiable information may be obfuscated. For example, if the online system 140 receives user-identifying information from a partnering third-party system 130A that includes a full name and a home address of an individual, the full name and the home address may be encrypted using a cryptographic hash function that creates hashes of the full name and the home address.

In some embodiments, user-identifying information also may include additional types of information that potentially may be combined with other personal information to identify an individual. These additional types of information may include an age, a gender, a geographic region, an occupation, an educational institution attended, hobbies/interests, or any other suitable types of information associated with an individual that may be maintained in the online system 140. For example, a combination of a first name, an age, a gender, a hometown, and an occupation associated with an individual may be used to identify the individual.

In some embodiments, the online system 140 may receive user-identifying information for users of the online system 140 via a partner tag added to a content item by a partnering third-party system 130A. In some embodiments, a partner tag that is added to a content item may be configured to communicate information describing a request associated with the content item to a partnering third-party system 130A that added the partner tag to the content item, which the partnering third-party system 130A may then communicate to the online system 140. A request associated with a content item may correspond to a request to present the content item, a request to perform an action associated with the content item (e.g., a request to make a purchase associated with the content item or a request to share the content item with additional online system users), a request to access additional content associated with the content item, a request to check-in to a physical location associated with the content item, etc. Information describing a request associated with a content item may include user-identifying information for a user of the online system 140 from whom the request was received, information identifying the content item associated with the request, information describing a type of request received at a content publisher 130C (e.g., to present the content item, to perform an action associated with the content item, etc.), a date/time of the request, etc.

To illustrate an example of how the online system 140 may receive user-identifying information for users of the online system 140 via a partner tag added to a content item by a partnering third-party system 130A, suppose that a partnering third-party system 130A adds a partner tag to a content item and provides the content item to a content publisher 130C. In this example, if the content publisher 130C presents the content item to a user of the online system 140 who then clicks on the content item, the partnering third-party system 130A may receive user-identifying information for the user, information identifying the content item, information indicating that the user clicked on the content item, and information indicating a time at which the user clicked on the content item. Continuing with this example, the partnering third-party system 130A may then forward some or all of this information to the online system 140.

In various embodiments, user-identifying information that is communicated to a partnering third-party system 130A may not include user-identifying information that is unique to an online system user in the online system 140, such that this information is maintained exclusively in the online system 140. Examples of user-identifying information that may be maintained exclusively in the online system 140 include a cookie identifier, a username, or a user identification number that is unique to a user in the online system 140. For example, suppose that a cookie identifier that is unique to an online system user in a partnering third-party system 130A and an additional cookie identifier that is unique to the online system user in the online system 140 are stored in a client device 110 associated with the online system user. In this example, suppose also that a partner tag is added to a content item by a partnering third-party system 130A. Continuing with this example, if a content publisher 130C receives a request to present the content item from the client device 110, information describing the request that is communicated to the partnering third-party system 130A via the partner tag may include the cookie identifier that is unique to the user in the partnering third-party system 130A, but may not include the cookie identifier that is unique to the user in the online system 140.

In various embodiments, a partner tag also may be configured to redirect information describing a request associated with a content item to the online system 140 when a content publisher 130C receives the request associated with the content item. For example, suppose that a partner tag that is added to a content item by a partnering third-party system 130A is configured to redirect information describing a request associated with the content item to the partnering third-party system 130A and to the online system 140. In this example, upon receipt of a request associated with the content item at a content publisher 130C, the partner tag may instruct a browser on a client device 110 from which the request was received to communicate information describing the request to the online system 140.

Trusted third-party systems 130B are neutral third-party systems 130 that are trusted by both the online system 140 and one or more partnering third-party systems 130A to compile one or more reports that include various analytics that describe one or more performance metrics for one or more content items presented to online system users by one or more content publishers 130C. Examples of performance metrics include impression performance metrics, revenue performance metrics, interaction performance metrics, etc. For example, a trusted third-party system 130B may compute impression performance metrics and revenue performance metrics for a content item based on information describing impressions and conversions achieved by the content item when presented to online system users by different content publishers 130C. In this example, the trusted third-party system 130B may then generate various analytics describing the performance metrics and compile the analytics into a report.

A trusted third-party system 130B may compile a report based at least in part on information describing requests associated with content items received at various content publishers 130C. As described above, information describing a request associated with a content item received at a trusted third-party system 130B may include user-identifying information for a user from whom the request was received, information identifying the content item associated with the request, information describing a type of request received at a content publisher 130C, a date/time of the request, etc. A trusted third-party system 130B may receive information describing a request associated with a content item from various sources. For example, when a partnering third-party system 130A receives information describing a request to present a content item to an online system user at a content publisher 130C (e.g., via a partner tag), the partnering third-party system 130A may communicate information describing the request to a trusted third-party system 130B. Alternatively, in the above example, information describing the request may be communicated to the trusted third-party system 130B by the online system 140, which receives the information from the partnering third-party system 130A or via a partner tag. As another alternative to the above examples, the information describing the request may be communicated to the trusted third-party system 130B via a partner tag configured to redirect information describing the request associated with the content item to the trusted third-party system 130B when the content publisher 130C receives the request associated with the content item.

A trusted third-party system 130B also may compile a report based at least in part on information describing an association among a set of user-identifying information for one or more online system users received from one or more identity providers, such as the online system 140. The information describing an association among a set of user-identifying information may indicate that the information is associated with the same online system user. For example, information describing an association among a set of user-identifying information may indicate that a cookie identifier that is unique to an online system user in a partnering third-party system 130A and a user identification number that is assigned to the user by the partnering third-party system 130A are associated with the same online system user.

In some embodiments, a trusted third-party system 130B may compile a report by determining a sequence of events associated with a content item based on information describing multiple requests associated with the content item received from an online system user. For example, a trusted third-party system 130B may receive information from a partnering third-party system 130A describing a request to present a content item at a first content publisher 130C received from an online system user associated with a first cookie identifier and a second request to access additional content associated with the same content item subsequently received at a second content publisher 130C from an online system user associated with a second cookie identifier. In this example, if information received from the online system 140 indicates that the first cookie identifier and the second cookie identifier are associated with the same online system user, the trusted third-party system 130B may determine that the user requested to access additional content associated with the content item at the second content publisher 130C after being presented with the content item by the first content publisher 130C and compile a report based on this determination. In various embodiments, a report may be compiled by multiple trusted third-party systems 130B. In the above example, a first trusted third-party system 130B may determine the sequence of events and then communicate information describing the sequence of events to a second trusted third-party system 130B. In this example, the second trusted third-party system 130B may then generate the analytics associated with the content item based on the sequence of events and compile them into the report.

In some embodiments, a trusted third-party system 130B also may compile a report based on information received from identity providers other than the online system 140. In such embodiments, the trusted third-party system 130B may aggregate the information received from multiple identity providers prior to compiling the report. For example, a trusted third-party-system 130B may receive information from a first identity provider indicating that a username that is unique to a user in a partnering third-party system 130A is associated with a client device identifier and information from a second identity provider indicating that a cookie identifier that is unique to a user in a partnering third-party system 130A is associated with the same client device identifier. In this example, the trusted third-party system 130B may aggregate the information received from the first and second identity providers, such that the username, the client device identifier, and the cookie identifier are associated with the same online system user 140. Continuing with this example, if the trusted third-party system 130B receives information describing requests associated with content items received from a user of the online system 140 associated with the username, the cookie identifier, and/or the client device identifier, the trusted third-party system 130B may determine that the requests are attributable to the same online system user and compile a report based on this determination.

In embodiments in which a trusted third-party system 130B receives information describing associations among sets of user-identifying information from multiple identity providers, the information received from different identity providers may be inconsistent. For example, a trusted third-party system 130B may receive information from a first identity provider indicating that a cookie identifier that is unique to an online system user in a partnering third-party system 130A is associated with a client device identifier. In this example, the trusted third-party system 130B also may receive information from a second identity provider indicating that the cookie identifier is associated with a different client device identifier, such that information received at the trusted third-party system 130B from the first and second identity providers are inconsistent.

In various embodiments, a trusted third-party system 130B may resolve inconsistencies among information describing associations among sets of user-identifying information provided by different identity providers by applying various rules. In some embodiments, a rule applied by a trusted third-party system 130B may be based on different priorities associated with different identity providers. For example, a rule may specify a ranking of different identity providers based on different priorities associated with the identity providers, such that if inconsistent information is provided to the trusted-third-party system 130B by different identity providers, the information provided by the highest ranked identity provider (i.e., the identity provider having the highest priority) is used to compile a report. In embodiments in which different identity providers are associated with different priorities, inconsistencies among the information may be resolved dynamically depending on the identity providers that provided the inconsistent information. In some embodiments, rules applied by a trusted third-party system 130B to resolve inconsistencies among information received from different identity providers may be specified by a partnering third-party system 130A. For example, a trusted third-party system 130B may receive various rules from different partnering third-party systems 130A, such that if inconsistent information includes information describing associations among sets of user-identifying information that are maintained in a partnering third-party system 130A, the trusted third-party system 130B may apply one or more rules received from the partnering third-party system 130A to resolve the inconsistency.

A trusted third-party system 130B also may resolve inconsistencies among information provided by different identity providers by computing a score associated with information provided by each identity provider. A score associated with information provided by an identity provider may be computed by a trusted third-party system 130B based on a model maintained in a partnering third-party system 130A. For example, a model maintained in a partnering third-party system 130A may specify a weight associated with information provided by an identity provider based on a priority associated with the identity provider, the type of information provided, a time that the information was provided, etc. Based on a score associated with information provided by each identity provider, a trusted third-party system 130B may resolve inconsistencies among the information (e.g., by using information associated with the highest scores to compile a report).

A report compiled by a trusted third-party system 130B may be communicated by the trusted third-party system 130B to a partnering third-party system 130A, to a content publisher 130C, or to a content provider (e.g., an advertiser). For example, if a trusted third-party system 130B compiles a report based on user-identifying information that is maintained in a partnering third-party system 130A, the trusted third-party system 130B may communicate the report to the partnering third-party system 130A. In this example, if the report compiled by the trusted third-party system 130B includes various analytics for a content item, the report also may be communicated to a content provider associated with the content item. Additionally, in this example, if the report includes analytics describing the presentation of the content item by a content publisher 130C, the report also may be communicated to the content publisher 130C.

FIG. 2 is a block diagram of an architecture of the online system 140. The online system 140 shown in FIG. 2 includes a user profile store 205, a content store 210, an action logger 215, an action log 220, an edge store 225, an identity comparison module 230, an identity resolution module 235, an unmatched identity store 240, an identity retention module 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes for the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

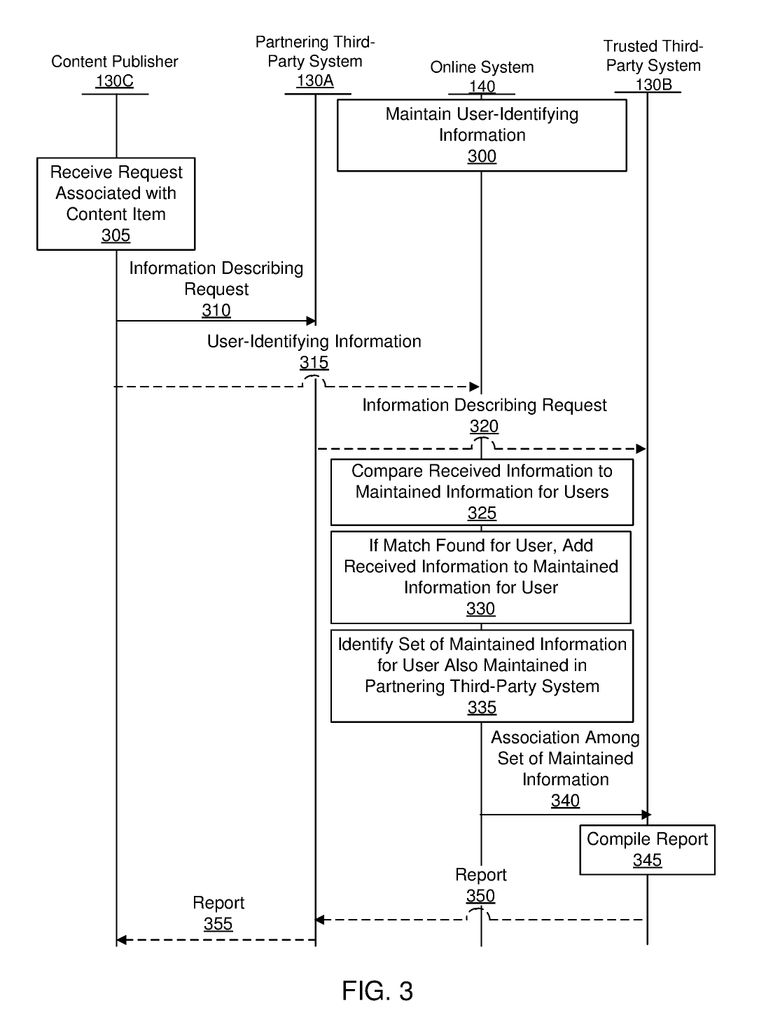

In some embodiments, user-identifying information maintained (e.g., as shown in step 300 of FIG. 3) in the user profile store 205 is generated and/or assigned by the online system 140. For example, when a user of the online system 140 requests to access a page maintained in the online system 140, the online system 140 may determine whether the request includes a cookie identifier that is unique to the user in the online system 140. In this example, if the request does not include a cookie identifier that is unique to the user in the online system 140, the online system 140 may set a cookie in a client device 110 from which the request was received by generating a cookie identifier that is unique to the user in the online system 140 and by storing it in the client device 110 and in the user profile store 205 in association with a user profile of the user. Continuing with this example, if the online system 140 subsequently receives an additional request from the user to access another page maintained in the online system 140, the request may include the cookie identifier, allowing the user to be identified by the online system 140.

User-identifying information maintained in the user profile store 205 also may be received from users of the online system 140. For example, when the online system 140 receives a request from a prospective user of the online system 140 to create a user account, the online system 140 may require the prospective user to provide user-identifying information such as a first name, a last name, and an email address. In this example, the online system 140 also may request that the prospective user provide optional user-identifying information such as a profile picture, a phone number, a birthdate, a geographic location, an occupation, hobbies/interests, etc. Continuing with this example, upon receiving the user-identifying information, the online system 140 may store the information in the user profile store 205 in association with a user profile of the user. As an additional example, upon receiving a request from a user of the online system 140 to access a page maintained in the online system 140, the online system 140 may receive user-identifying information (e.g., a cookie identifier, an IP address, etc.) stored in a cookie in a client device 110 from which the request was received.

The online system 140 may store user-identifying information in the user profile store 205 in association with information describing its receipt. In some embodiments, user-identifying information stored in the user profile store 205 may be stored in association with information describing when, how, and from whom the user-identifying information was received. For example, if the online system 140 receives an IP address associated with an online system user from a partnering third-party system 130A, the online system 140 may store the IP address in association with a user profile of the user, a date and a time that the IP address was received, information indicating that the IP address was received from a partnering third-party system 130A, and information identifying the partnering third-party system 130A.

In various embodiments, the online system 140 may receive user-identifying information for a user of the online system 140 in response to the receipt of a request associated with a content item from the user at a content publisher 130C. As described above, a request associated with a content item may correspond to a request to present the content item, a request to perform an action associated with the content item (e.g., a request to make a purchase associated with the content item or a request to share the content item with additional online system users), a request to access additional content associated with the content item, a request to check-in to a physical location associated with the content item, etc. For example, the online system 140 may receive a browser identifier and a cookie identifier associated with an online system user when a content publisher 130C receives a request associated with a content item from the user. In some embodiments, the content publisher 130C may be the online system 140. In the above example, the online system 140 may receive the browser identifier and the cookie identifier associated with the user when the online system 140 receives the request associated with the content item from the user.

In embodiments in which the online system 140 receives user-identifying information for a user of the online system 140 in response to the receipt of a request associated with a content item from the user at a content publisher 130C, the online system 140 may receive the user-identifying information via a cookie stored in a client device 110 associated with the online system user. For example, if the online system 140 is a content publisher 130C and receives a request to access a page maintained in the online system 140, the online system 140 may set a cookie in a client device 110 from which the request was received by generating a cookie identifier that is stored in the client device 110 and in the user profile store 205 in association with a user profile of the user. In this example, upon receiving a request to present a content item to the same online system user, the online system 140 may receive user-identifying information for the user in conjunction with the request from the cookie previously stored in the client device 110 by the online system 140.

As described above, in some embodiments, the online system 140 may receive user-identifying information for a user of the online system 140 in response to the receipt of a request associated with a content item from the user at a content publisher 130C via a partner tag added to the content item by a partnering third-party system 130A. For example, the online system 140 may receive user-identifying information for a user of the online system 140 included among information describing a request associated with a content item upon receipt of the request from the user at a content publisher 130C. In the above example, the online system 140 may receive the user-identifying information via a partner tag added to the content item or from a partnering third-party system 130A, which receives the user-identifying information via the partner tag added to the content item.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions in the online system 140, as well as actions in the third-party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

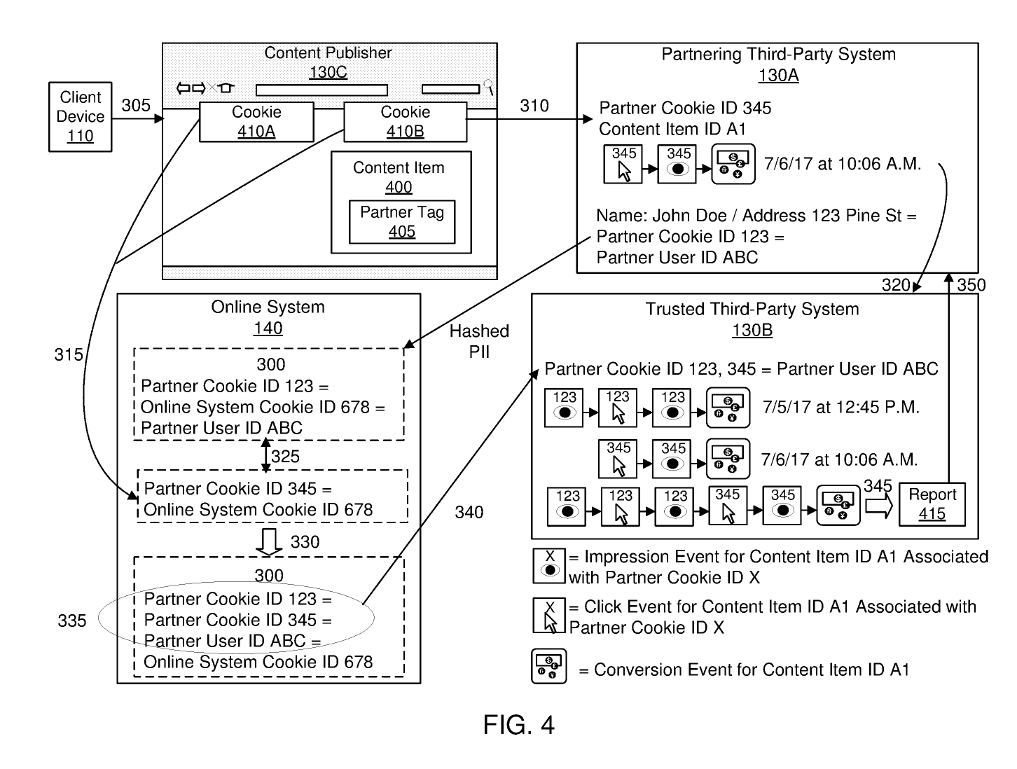

The identity comparison module 230 may compare (e.g., as shown in step 325 of FIGS. 3 and 4) user-identifying information received at the online system 140 to user-identifying information maintained in the online system 140 for various online system users. In some embodiments, the identity comparison module 230 compares user-identifying information received at the online system 140 to user-identifying information of the same type maintained in the online system 140. For example, if the online system 140 receives a first cookie identifier that is unique to a user in the online system 140 in conjunction with a second cookie identifier that is unique to the user in a partnering third-party system 130A, the identity comparison module 230 may compare the first cookie identifier to cookie identifiers maintained in the user profile store 205 that are unique to the users in the online system 140. In this example, the identity comparison module 230 also may compare the second cookie identifier to cookie identifiers maintained in the user profile store 205 that are unique to the users in the partnering third-party system 130A. As an additional example, if the online system 140 receives an IP address in conjunction with an email address associated with an individual, the identity comparison module 230 may compare the IP address and the email address to IP addresses and email addresses maintained in the online system 140 for various online system users.

In some embodiments, to compare user-identifying information received at the online system 140 to user-identifying information maintained in the online system 140 for various online system users, the identity comparison module 230 may first identify various types of user-identifying information received at the online system 140 and/or maintained in the online system 140. Examples of types of user-identifying information include first and last names, IP addresses, cookie identifiers, email addresses, phone numbers, etc. For example, the identity comparison module 230 may determine if user-identifying information received at the online system 140 includes an IP address written in IPv4 notation based on whether the information includes a 32-bit number written in dot-decimal notation. In this example, the identity comparison module 230 also may determine if the user-identifying information includes an IP address written in IPv6 notation based on whether the information includes a 128-bit number, in which every 16 bits are separated by colons. As an additional example, the identity comparison module 230 may identify user-identifying information maintained in the online system 140 corresponding to an email address based on whether at least some of the format of the user-identifying information conforms to the format of an email address. In this example, if the user-identifying information maintained in the online system 140 includes the email address “John.Doe@example.com,” the identity comparison module 230 may determine that the user-identifying information includes an email address since “John.Doe@example.com” conforms to the format of an email address (i.e., a string having a local part (John.Doe) and a domain (example.com) separated by an @ symbol).

In various embodiments, the identity comparison module 230 also may identify various types of user-identifying information maintained in the online system 140 based on information stored in association with user profiles of various online system users (e.g., in the user profile store 205). For example, the identity comparison module 230 may access the user profile store 205 and identify a cookie identifier as a cookie identifier that is unique to an online system user in a partnering third-party system 130A as opposed to a cookie identifier that is unique to the user in the online system 140 based on information stored in association with the cookie identifier indicating that the cookie identifier was received from the partnering third-party system 130A.

In embodiments in which user-identifying information received at the online system 140 is obfuscated, the identity comparison module 230 may compare the obfuscated information to information maintained in the online system 140 that is similarly obfuscated. For example, if the online system 140 receives an IP address that is encrypted using a cryptographic hash function, the identity comparison module 230 may create hashes of the IP addresses maintained in the user profile store 205 for various online system users using the same cryptographic hash function. In this example, the identity comparison module 230 may then compare the hash of the IP address received at the online system 140 to the hashes of the IP addresses maintained in the user profile store 205.

In embodiments in which the online system 140 stores unmatched user-identifying information (e.g., in the unmatched identity store 240, described below), the identity comparison module 230 may compare unmatched user-identifying information stored in the online system 140 to user-identifying information maintained in the online system 140 for various online system users. For example, the identity comparison module 230 may compare an IP address and a cookie identifier stored in the unmatched identity store 240 to IP addresses and cookie identifiers maintained in the user profile store 205 for various online system users. In embodiments in which the identity comparison module 230 compares unmatched user-identifying information to user-identifying information maintained in the online system 140 for various online system users, the identity comparison module 230 may make such comparisons periodically (e.g., once a week). Alternatively, in embodiments in which the identity comparison module 230 compares unmatched user-identifying information to user-identifying information maintained in the online system 140 for various online system users, the identity comparison module 230 may make such comparisons after user-identifying information has been added to user-identifying information maintained in the online system 140 (e.g., by the identity resolution module 235, described below). For example, after an IP address has been added to user-identifying information maintained in the online system 140 for an online system user, the identity comparison module 230 may compare this IP address to IP addresses stored in the unmatched identity store 240.

Once the identity comparison module 230 has compared user-identifying information received at the online system 140 to user-identifying information maintained in the online system 140, the identity comparison module 230 may determine if the user-identifying information received at the online system 140 matches user-identifying information of the same type maintained in the online system 140 for a particular online system user. For example, if the identity comparison module 230 has compared a cookie identifier that is unique to an individual in a partnering third-party system 130A to cookie identifiers maintained in the user profile store 205 that are unique to various online system users in the partnering third-party system 130A, the identity comparison module 230 may determine if the cookie identifier received at the online system 140 matches any cookie identifiers to which it was compared. In embodiments in which the identity comparison module 230 compares unmatched user-identifying information stored in the online system 140 to user-identifying information maintained in the online system 140 for various online system users, the identity comparison module 230 may determine if the unmatched user-identifying information matches user-identifying information maintained in the online system 140 for a particular user. The functionality of the identity comparison module 230 is further described below in conjunction with FIGS. 3 and 4.

The identity resolution module 235 adds (e.g., as shown in step 330 of FIGS. 3 and 4) user-identifying information received at the online system 140 to user-identifying information maintained in the online system 140. The identity resolution module 235 may add user-identifying information received at the online system 140 to user-identifying information maintained in the online system 140 based on whether any user-identifying information received at the online system 140 matches any user-identifying information of the same type maintained in the online system 140 for a particular user. In some embodiments, if at least some user-identifying information received at the online system 140 matches at least some user-identifying information of the same type maintained in the online system 140 for a user of the online system 140, the identity resolution module 235 may create a combined set of user-identifying information by adding the received information to the user-identifying information maintained in the online system 140 for that user. For example, suppose that the online system 140 receives a first cookie identifier in conjunction with a second cookie identifier, in which the first cookie identifier is unique to an online system user in the online system 140 and the second cookie identifier is unique to the user in a partnering third-party system 130A. In this example, if the first cookie identifier matches a cookie identifier included among user-identifying information maintained in the online system 140 for the user, the identity resolution module 235 may add the second cookie identifier to the user-identifying information maintained in the online system 140 for the user, creating a combined set of user-identifying information for the user that is maintained in the online system 140.

In various embodiments, if user-identifying information received at the online system 140 does not match user-identifying information maintained in the online system 140 for any user of the online system 140, the identity resolution module 235 may store this unmatched user-identifying information (e.g., in the unmatched identity store 240, described below). For example, suppose that the online system 140 receives a cookie identifier in conjunction with an IP address, in which the cookie identifier is unique to an individual in a partnering third-party system 130A. In this example, if neither the cookie identifier nor the IP address matches a cookie identifier or an IP address included among user-identifying information maintained in the online system 140 for an online system user, the identity resolution module 235 may store the cookie identifier and the IP address in the unmatched identity store 240. In alternative embodiments, if the identity comparison module 230 determines that user-identifying information received at the online system 140 does not match user-identifying information maintained in the online system 140 for a user of the online system 140, the identity resolution module 235 may discard the user-identifying information.

In embodiments in which the identity resolution module 235 stores unmatched user-identifying information, the identity resolution module 235 may add previously unmatched user-identifying information to user-identifying information maintained in the online system 140 for a particular user. For example, if an IP address stored in the unmatched identity store 240 matches an IP address maintained in the user profile store 205 for a particular user of the online system 140, the identity resolution module 235 may create a combined set of user-identifying information by adding a cookie identifier stored in association with the IP address in the unmatched identity store 240 to the user-identifying information maintained in the user profile store 205 for the user, creating a combined set of user-identifying information maintained in the user profile store 205 for the user.

If user-identifying information received at the online system 140 matches user-identifying information of the same type maintained in the online system 140 for multiple online system users, the identity resolution module 235 may create a combined set of user-identifying information maintained in the online system 140 for each user by adding the received information to the user-identifying information maintained in the online system 140 for each user (e.g., in the user profile store 205). For example, suppose the online system 140 receives an IP address associated with a client device 110 in conjunction with a cookie identifier that is unique to an individual in a partnering third-party system 130A and the cookie identifier does not match any cookie identifiers stored in the user profile store 205. In this example, if the IP address matches an IP address stored in the user profile store 205 in association with user profiles of two online system users, the identity resolution module 235 may store the cookie identifier in the user profile store 205 in association with the user profiles of both of the online system users. In an alternative embodiment, the identity resolution module 235 may discard user-identifying information received at the online system 140 that matches user-identifying information maintained in the online system 140 for multiple online system users. The functionality of the identity resolution module 235 is further described below in conjunction with FIGS. 3 and 4.

In various embodiments, if user-identifying information received at the online system 140 does not match user-identifying information maintained in the online system 140 for an online system user, this unmatched user-identifying information may be stored in the unmatched identity store 240 with other user-identifying information received at the online system 140 that is not associated with a particular user of the online system 140. For example, if the online system 140 receives an IP address associated with a client device 110 in conjunction with a cookie identifier that is unique to an individual in a partnering third-party system 130A and neither the IP address nor the cookie identifier matches any IP address or cookie identifier stored in the user profile store 205, the IP address may be stored in association with the cookie identifier in the unmatched identity store 240 for later retrieval (e.g., by the identity comparison module 230 and/or by the identity resolution module 235). The unmatched identity store 240 is further described below in conjunction with FIG. 3.

The identity retention module 245 identifies (e.g., as shown in step 335 of FIGS. 3 and 4) user-identifying information maintained in the online system 140 and in a partnering third-party system 130A for the same online system user. For example, suppose that a cookie identifier and a username that are unique to an online system user in a partnering third-party system 130A are added to user-identifying information maintained in the online system 140 for the user, creating a combined set of user-identifying information for the user that is maintained in the online system 140. In this example, the identity retention module 245 may identify the cookie identifier and the username as user-identifying information that is maintained in the online system 140 and in the partnering third-party system 130A for the same user since the cookie identifier and the username are unique to the user in the partnering third-party system 130A. In the above example, if the user-identifying information maintained in the online system 140 for the user also includes a username that is unique to the user in the online system 140, the identity retention module 245 may not identify the username as user-identifying information that is maintained in the online system 140 and in the partnering third-party system 130A for the same user since it is maintained only in the online system 140.

The identity retention module 245 may identify user-identifying information maintained in the online system 140 and in a partnering third-party system 130A based on information stored in association with a user profile of the user (e.g., in the user profile store 205). For example, upon receiving a username from a partnering third-party system 130A that is unique to a user of the online system 140 in the partnering third-party system 130A, the online system 140 may store the username in the user profile store 205 in association with a user profile of the user, a date and a time that the username was received, and information indicating that the username was received from the partnering third-party system 130A. In this example, the identity retention module 245 subsequently may access the user profile store 205 and identify the username as user-identifying information that is maintained in the online system 140 and in the partnering third-party system 130A based on the information indicating that the username was received from the partnering third-party system 130A. As an additional example, suppose that the online system 140 receives a cookie identifier from a partnering third-party system 130A that is associated with metadata indicating that the cookie identifier is unique to a user of the online system 140 in the partnering third-party system 130A. In this example, the online system 140 may store the cookie identifier in the user profile store 205 in association with a user profile of the user and the metadata indicating that the cookie identifier is unique to the user in the partnering third-party system 130A. Continuing with this example, the identity retention module 245 subsequently may access the user profile store 205 and identify the cookie identifier as user-identifying information that is maintained in the partnering third-party system 130A based on the metadata associated with the cookie identifier. The functionality of the identity retention module 245 is further described below in conjunction with FIGS. 3 and 4.

The web server 250 links the online system 140 via the network 120 to the one or more client devices 110, as well as to the third-party system 130 and/or one or more third-party systems 130. The web server 250 serves web pages, as well as other content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, WEBOS® or BlackberryOS.

### Identifying an Association Among User-Identifying Information Maintained in a Third-Party System for a User of an Online System

FIG. 3 is an interaction diagram of a method for identifying an association among user-identifying information maintained in a third-party system for a user of an online system. In other embodiments, the method may include different and/or additional steps than those shown in FIG. 3. Additionally, steps of the method may be performed in a different order than the order described in conjunction with FIG. 3.

The online system 140 may maintain 300 user-identifying information for users of the online system 140 (e.g., in the user profile store 205). User-identifying information for a user maintained 300 in the online system 140 may include personally identifiable information that may be used to identify an individual. Examples of personally identifiable information for an online system user include the user's full name, home address, phone number, email address, a user identifier that is unique to the user in the online system 140 or in a partnering third-party system 130A (e.g., a username, a user identification number, or a cookie identifier), a client device identifier (e.g., an IP address) or a browser identifier (e.g., a user agent) associated with the user, etc. In some embodiments, user-identifying information also may include additional types of information that potentially may be combined with other personal information to identify an individual. These additional types of information may include an age, a gender, a geographic region, an occupation, an educational institution attended, hobbies/interests, or any other suitable types of information associated with an individual that may be maintained 300 in the online system 140. For example, a combination of a first name, an age, a marital status, and an occupation associated with an individual may be used to identify the individual.

In some embodiments, user-identifying information maintained 300 in the online system 140 may be generated and/or assigned by the online system 140. For example, when a user of the online system 140 requests to access a page maintained in the online system 140, the online system 140 may determine whether the request includes a cookie identifier that is unique to the user in the online system 140. In this example, if the request does not include a cookie identifier that is unique to the user in the online system 140, the online system 140 may set a cookie in a client device 110 from which the request was received by generating a cookie identifier that is unique to the user in the online system 140 and by storing it in the client device 110 and in the user profile store 205 in association with a user profile of the user. Continuing with this example, if the online system 140 subsequently receives an additional request from the user to access another page maintained in the online system 140, the request may include the cookie identifier, allowing the user to be identified by the online system 140.

User-identifying information maintained 300 in the online system 140 may be received from users of the online system 140. For example, when the online system 140 receives a request from a prospective user of the online system 140 to create a user account, the online system 140 may require the prospective user to provide user-identifying information such as a first name, a last name, and an email address. In this example, the online system 140 also may request that the prospective user provide optional user-identifying information such as a profile picture, a phone number, a birthdate, a geographic location (e.g., a hometown), an occupation, hobbies/interests, etc. Continuing with this example, upon receiving the user-identifying information, the online system 140 may store it in association with a user profile of the user maintained in the online system 140. As an additional example, upon receiving a request from a user of the online system 140 to access a page maintained in the online system 140, the online system 140 may receive user-identifying information (e.g., a cookie identifier, an IP address, a browser identifier, etc.) stored in a cookie in a client device 110 from which the request was received.

User-identifying information also may be received from various partnering third-party systems 130A. For example, the online system 140 may receive various types of user-identifying information for an online system user from a partnering third-party system 130A, such as the user's name and home address and a user identification number that is unique to the user in the partnering third-party system 130A. In embodiments in which user-identifying information received from a partnering third-party system 130A includes personally identifiable information associated with online system users, the personally identifiable information may be obfuscated. For example, if the online system 140 receives user-identifying information from a partnering third-party system 130A that includes a name and a home address of an online system user, the name and the home address may be encrypted using a cryptographic hash function that creates hashes of the name and the home address.

As shown in the example of FIG. 4, user-identifying information maintained 300 in the online system 140 for a particular online system user includes a cookie identifier that is unique to the user in a partnering third-party system 130A (Partner Cookie ID 123), a cookie identifier that is unique to the user in the online system 140 (Online System Cookie ID 678) and a username that is unique to the user in the partnering third-party system 130A (Partner User ID ABC). In this example, the online system 140 may receive the cookie identifier and the username that are unique to the user in the partnering third-party system 130A (Partner Cookie ID 123 and Partner User ID ABC) in conjunction with hashed personally identifiable information for the user (Hashed PII), such as a hashed first and last name (e.g., a hash of “John Doe”) and a hashed home address (e.g., a hash of “123 Pine St.”). The user-identifying information maintained 300 in the online system for the user may be obtained by determining that at least some of the information received from the partnering third-party system 130A matches at least some of the user-identifying information maintained 300 in the online system 140 for the user, as described below.

The online system 140 may store user-identifying information in association with information describing its receipt. In some embodiments, the user-identifying information maintained 300 in the online system 140 is stored in association with information describing when, how, and from whom the user-identifying information was received. For example, if the online system 140 receives an IP address associated with an online system user from a partnering third-party system 130A, the online system 140 may store the IP address in association with a user profile of the user, a date and a time that the IP address was received, information indicating that the IP address was received from a partnering third-party system 130A, and information identifying the partnering third-party system 130A.

Referring back to FIG. 3, a content publisher 130C may receive 305 a request associated with a content item from a user of the online system 140. Examples of a request associated with a content item include a request to present the content item, a request to perform an action associated with the content item (e.g., a request to make a purchase associated with the content item or a request to share the content item with additional online system users), a request to access additional content associated with the content item, a request to check-in to a physical location associated with the content item, etc. For example, a content publisher 130C may present a content item to a user of the online system 140, in which the content item includes an interactive element corresponding to an option to express a preference for the content item (e.g., a “like” button). In this example, the content publisher 130C may receive 305 a request to express a preference for the content item from the user of the online system 140 if the user clicks on the interactive element. As an additional example, if a content item is an advertisement for a new movie, a content publisher 130C may receive 305 a request to access additional information associated with the movie from a user of the online system 140 if the user clicks on the content item. In some embodiments, the content publisher 130C may be the online system 140. For example, the online system 140 may present a feed of content items to a user of the online system 140 that is specific to the user (e.g., a newsfeed). In this example, the online system 140 may receive 305 a request from the user to share a content item included in the newsfeed with additional users of the online system 140 (e.g., if the user clicks on a “share” button).

In the example of FIG. 4, a content publisher 130C receives 305 a request associated with a content item 400 from a client device 110 associated with an online system user via a web page for the content publisher 130C. In this example, the content item 400 includes a partner tag 405 that was added to the content item 400 by a partnering third-party system 130A. Furthermore, as shown in this example, a cookie 410A has been set in the client device 110 by the online system 140, while another cookie 410B has been set in the client device 110 by the partnering third-party system 130A.

Referring again to FIG. 3, responsive to receiving 305 the request associated with the content item 400 from the user of the online system 140 at the content publisher 130C, a partnering third-party system 130A may receive 310 information describing the request. Information describing the request associated with the content item 400 may include user-identifying information for the user from whom the request was received 305, information identifying the content item 400 associated with the request, information describing a type of request received 305 at the content publisher 130C (e.g., to present the content item 400, to perform an action associated with the content item 400, etc.), a date/time of the request, etc. For example, if a content publisher 130C receives 305 a request from a user of the online system 140 to purchase a product associated with a content item 400, a partnering third-party system 130A may receive 310 information describing the request, such as user-identifying information for the user (e.g., an IP address associated with a client device 110 associated with the user), an identifier associated with the content item 400, information indicating that the request was to purchase a product associated with the content item 400, information identifying the product the user requested to purchase, a time that the request was received 305 by the content publisher 130C, etc.

In some embodiments, the partnering third-party system 130A may receive 310 the information describing the request via a partner tag 405 added to the content item 400 by the partnering third-party system 130A that is configured to communicate information describing the request to the partnering third-party system 130A. For example, when an online system user clicks on a content item 400 tagged with a partner tag 405, a partnering third-party system 130A that added the partner tag 405 to the content item 400 may receive 310 user-identifying information for the user, information indicating that the user clicked on the content item 400, information identifying the content item 400, and information indicating a time at which the user clicked on the content item 400.

As illustrated in FIG. 4, since the content item 400 is tagged with the partner tag 405 that was added to the content item 400 by the partnering third-party system 130A, the partnering third-party system 130A receives 310 information describing the request associated with the content item 400 once the request has been received 305 at the content publisher 130C from the client device 110. In this example, the partner tag 405 may instruct a browser on the client device 110 from which the request was received 305 to retrieve the information describing the request from the cookie 410B previously set in the client device 110 by the partnering third-party system 130A and to communicate this information to the partnering third-party system 130A. Information describing the request in this example includes user-identifying information for the user (Partner Cookie ID 345), information identifying the content item 400 (Content Item ID A1), information describing events associated with the content item 400 (i.e., a click event, an impression event, and a conversion event), and a date and time associated with the events (7/6/17 at 10:06 A.M.).

In some embodiments, user-identifying information that is included among information describing the request that is received 310 by the partnering third-party system 130A may not include user-identifying information that is unique to the online system user in the online system 140 (e.g., a cookie identifier, a username, or a user identification number that is unique to the user in the online system 140), such that this information is maintained exclusively in the online system 140. For example, suppose that a cookie identifier that is unique to an online system user in a partnering third-party system 130A and an additional cookie identifier that is unique to the online system user in the online system 140 are stored in a client device 110 associated with the online system user. In this example, suppose also that a partner tag 405 is added to a content item 400 by a partnering third-party system 130A. Continuing with this example, if a content publisher 130C receives 305 a request to present the content item 400 from the client device 110, information describing the request that is received 310 by the partnering third-party system 130A via the partner tag 405 may include the cookie identifier that is unique to the user in the partnering third-party system 130A, but may not include the cookie identifier that is unique to the user in the online system 140.

As shown in FIG. 4, information describing the request that is received 310 by the partnering third-party system 130A includes a cookie identifier that is unique to the user in the partnering third-party system 130A (Partner Cookie ID 345), information identifying the content item 400 (Content Item ID A1), information describing events associated with the content item 400, and a date/time associated with the events, which are stored in the cookie 410B previously set in the client device 110 by the partnering third-party system 130A. However, in this example, information describing the request that is received 310 by the partnering third-party system 130A does not include a cookie identifier that is unique to the user in the online system 140 (Online System Cookie ID 678), which is stored in the cookie 410A previously set in the client device 110 by the online system 140.

Referring back to FIG. 3, in various embodiments, in response to the receipt of the request associated with the content item 400 at the content publisher 130C from the user of the online system 140, the online system 140 may receive 315 user-identifying information for the user. For example, the online system 140 may receive 315 a browser identifier and a cookie identifier associated with an online system user when a content publisher 130C receives 305 a request associated with a content item 400 from the user. In some embodiments, the online system 140 may receive 315 the user-identifying information for the user via a cookie stored in a client device 110 associated with the online system user. For example, in embodiments in which the online system 110 is a content publisher 130C and receives 305 a request to access a page maintained in the online system 140, the online system 140 may set a cookie in a client device 110 from which the request was received 305 by generating a cookie identifier that is stored in the client device 110 and in the user profile store 205 in association with a user profile of the user. In this example, upon receiving 305 a request to present a content item 400 to the same online system user, the online system 140 may receive 315 user-identifying information for the user from the cookie previously stored in the client device 110 by the online system 140.

In embodiments in which the online system 140 receives 315 user-identifying information for the user in response to the receipt of the request associated with the content item 400 from the user at the content publisher 130C, the online system 140 also may receive 315 the user-identifying information via a partner tag 405 added to the content item 400 by the partnering third-party system 130A. For example, suppose that a partnering third-party system 130A adds a partner tag 405 to a content item 400 and provides the content item 400 to a content publisher 130C. In this example, if the content publisher 130C presents the content item 400 to a user of the online system 140 who then clicks on the content item 400, the partnering third-party system 130A may receive 310 user-identifying information for the user, information identifying the content item 400, information indicating that the user clicked on the content item 400, and information indicating a time at which the user clicked on the content item 400. Continuing with this example, the partnering third-party system 130A may then forward some or all of this information to the online system 140.

In various embodiments, the partner tag 405 also may be configured to redirect user-identifying information for the online system user to the online system 140 in response to the receipt of the request associated with the content item 400 from the user at the content publisher 130C. For example, suppose that a partner tag 405 that is added to a content item 400 by a partnering third-party system 130A is configured to redirect information describing a request associated with the content item 400 to the partnering third-party system 130A and to the online system 140. In this example, upon receipt of a request associated with the content item 400 at a content publisher 130C, the partner tag 405 may instruct a browser on a client device 110 from which the request was received to communicate information describing the request to the partnering third-party system 130A and to the online system 140.

As shown in the example of FIG. 4, the online system 140 may receive 315 user-identifying information via the partner tag 405 added to the content item 400, which redirects user-identifying information for the user to the online system 140 by instructing a browser on the client device 110 associated with the user to communicate the information describing the request associated with the content item 400 to the online system 140. In this example, information describing the request may be retrieved from the cookie 410A previously stored in the client device 110 by the online system 140 and from the cookie 410B previously stored in the client device 110 by the partnering third-party system 130A. Furthermore, in this example, the user-identifying information for the user received 315 by the online system 140 includes a cookie identifier that is unique to the user in the partnering third-party system 130A (Partner Cookie ID 345) and a cookie identifier that is unique to the user in the online system 140 (Online System Cookie ID 678).

Referring again to FIG. 3, information describing the request associated with the content item 400 received 305 at the content publisher 130C also may be communicated 320 to a trusted third-party system 130B. In some embodiments, upon receiving 310 information describing the request at the partnering third-party system 130A, the partnering third-party system 130A may communicate 320 the information to the trusted third-party system 130B. For example, when a partnering third-party system 130A receives 310 information describing a request to present a content item 400 to an online system user at a content publisher 130C (e.g., via a partner tag 405), the partnering third-party system 130A may communicate 320 information describing the request to the trusted third-party system 130B. In the example of FIG. 4, information describing the request (Partner Cookie ID 345, Content Item ID A1, events associated with Content Item ID A1, and a date/time associated with the events) is communicated 320 by the partnering third-party system 130A to the trusted third-party system 130B.

In some embodiments, upon receiving 315 information describing the request at the online system 140, the online system 140 may communicate 320 the information to the trusted third-party system 130B. In such embodiments, the online system 140 may receive 315 the information from the partnering third-party system 130A or via a partner tag 405. In additional embodiments, the information describing the request may be communicated 320 to the trusted third-party system 130B via a partner tag 405 configured to redirect information describing the request associated with the content item 400 to the trusted third-party system 130B when the content publisher 130C receives 305 the request associated with the content item 400.

Referring back to FIG. 3, the online system 140 may compare 325 (e.g., using the identity comparison module 230) the user-identifying information received 315 by the online system 140 to user-identifying information maintained 300 in the online system 140 for various online system users. In some embodiments, the online system 140 compares 325 user-identifying information received 315 by the online system 140 to user-identifying information of the same type maintained 300 in the online system 140. For example, if the online system 140 receives 315 a first cookie identifier that is unique to a user in the online system 140 in conjunction with a second cookie identifier that is unique to the user in a partnering third-party system 130A, the online system 140 may compare 325 the first cookie identifier to cookie identifiers maintained in the user profile store 205 that are unique to users in the online system 140. In this example, the online system 140 also may compare 325 the second cookie identifier to cookie identifiers maintained in the user profile store 205 that are unique to the users in the partnering third-party system 130A. As an additional example, if the online system 140 receives 315 an IP address in conjunction with an email address associated with an individual, the online system 140 may compare 325 the IP address and the email address to IP addresses and email addresses maintained 300 in the user profile store 205 for various online system users. In the example of FIG. 4, the online system 140 compares 325 the user-identifying information (Partner Cookie ID 345 and Online System Cookie ID 678) received 315 by the online system 140 to the user-identifying information (Partner Cookie ID 123, Online System Cookie ID 678, and Partner User ID ABC) maintained 300 in the online system 140 for an online system user.

In some embodiments, to compare 325 user-identifying information received 315 by the online system 140 to user-identifying information maintained 300 in the online system 140 for various online system users, the online system 140 may first identify (e.g., using the identity comparison module 230) one or more types of user-identifying information received 315 by the online system 140 and/or maintained 300 in the online system 140. Examples of types of user-identifying information include first and last names, IP addresses, cookie identifiers, email addresses, phone numbers, etc. For example, the online system 140 may identify user-identifying information received 315 by the online system 140 corresponding to an IP address written in IPv4 notation based on whether the information includes a 32-bit number written in dot-decimal notation or an IP address written in IPv6 notation based on whether the information includes a 128-bit number in which every 16 bits are separated by colons. As an additional example, the online system 140 may identify user-identifying information maintained 300 in the online system 140 corresponding to an email address based on whether at least some of the format of the user-identifying information conforms to the format of an email address. In this example, if the user-identifying information maintained 300 in the online system 140 includes the email address “Jane.Doe@example.com,” the online system 140 may determine that the user-identifying information includes an email address since “Jane.Doe@example.com” conforms to the format of an email address (i.e., a string having a local part (Jane.Doe) and a domain (example.com) separated by an @ symbol).

In various embodiments, the online system 140 also may identify various types of user-identifying information maintained 300 in the online system 140 based on information stored in association with various user profiles of online system users (e.g., in the user profile store 205). For example, the online system 140 may access the user profile store 205 and identify a cookie identifier as a cookie identifier that is unique to an online system user in a partnering third-party system 130A as opposed to a cookie identifier that is unique to the user in the online system 140 based on information stored in association with the cookie identifier indicating that the cookie identifier was received 315 from the partnering third-party system 130A.

In embodiments in which user-identifying information received 315 by the online system 140 is obfuscated, the online system 140 may compare 325 the obfuscated information to information maintained 300 in the online system 140 that is similarly obfuscated. For example, if the online system 140 receives 315 an IP address that is encrypted using a cryptographic hash function, the online system 140 may create hashes of the IP addresses maintained 300 in the user profile store 205 using the same cryptographic hash function. In this example, the online system 140 may then compare 325 the hash of the IP address received 315 by the online system 140 to the hashes of the IP addresses maintained 300 in the user profile store 205.

In embodiments in which the online system 140 stores unmatched user-identifying information (e.g., in the unmatched identity store 240), as described below, the online system 140 may compare 325 unmatched user-identifying information stored in the online system 140 to user-identifying information maintained 300 in the online system 140 for various users. For example, the online system 140 may compare 325 an IP address and a cookie identifier stored in the unmatched identity store 240 to IP addresses and cookie identifiers maintained 300 in the user profile store 205 for various online system users. In embodiments in which the online system 140 compares 325 unmatched user-identifying information to user-identifying information maintained 300 in the online system 140 for various users, the online system 140 may make such comparisons periodically (e.g., once a week). Alternatively, in embodiments in which the online system 140 compares 325 unmatched user-identifying information to user-identifying information maintained 300 in the online system 140 for various users, the online system 140 may make such comparisons after user-identifying information has been added to user-identifying information maintained 300 in the online system 140, as described below. For example, after an IP address has been added to user-identifying information maintained 300 in the online system 140, the online system 140 may compare 325 this IP address to IP addresses stored in the unmatched identity store 240.

Based on the comparison, the online system 140 may determine (e.g., using the identity comparison module 230) if the user-identifying information received 315 by the online system 140 matches user-identifying information of the same type maintained 300 in the online system 140 for a particular online system user. For example, if the online system 140 has compared 325 a cookie identifier that is unique to an individual in a partnering third-party system 130A to cookie identifiers maintained 300 in the user profile store 205 that are unique to various online system users in the partnering third-party system 130A, the online system 140 may determine if the cookie identifier received 315 by the online system 140 matches any cookie identifiers maintained 300 in the user profile store 205 to which it was compared 325. In embodiments in which the online system 140 compares 325 unmatched user-identifying information stored in the online system 140 (e.g., in the unmatched identity store 240) to user-identifying information maintained 300 in the online system 140 for various online system users, the online system 140 may determine if the unmatched user-identifying information stored in the online system 140 matches user-identifying information maintained 300 in the online system 140 for a particular user.

Referring back to FIG. 3, in response to determining that the user-identifying information received 315 by the online system 140 matches user-identifying information of the same type maintained 300 in the online system 140 for a particular online system user, the online system 140 may add 330 (e.g., using the identity resolution module 235) the received 315 information to information maintained 300 in the online system 140 for the user to create a combined set of user-identifying information maintained 300 in the online system 140 for the user. In some embodiments, the online system 140 may add 330 the received 315 information to a set of user-identifying information maintained 300 in the online system 140 for the user if the online system 140 determines that at least some user-identifying information received 315 by the online system 140 matches at least some user-identifying information of the same type maintained 300 in the online system 140 for the user. For example, suppose that the online system 140 receives 315 a first cookie identifier in conjunction with a second cookie identifier, in which the first cookie identifier is unique to an online system user in the online system 140 and the second cookie identifier is unique to the user in a partnering third-party system 130A. In this example, if the first cookie identifier matches a cookie identifier included among user-identifying information maintained 300 in the online system 140 for the user, the online system 140 may add 330 the second cookie identifier to the user-identifying information maintained 300 in the online system 140 for the user (e.g., in the user profile store 205), creating a combined set of user-identifying information for the user that is maintained 300 in the online system 140.

As shown in the example of FIG. 4, based on the comparison of the user-identifying information received 315 by the online system 140 to the user-identifying information maintained 300 in the online system 140 for an online system user, the online system 140 may determine that at least some user-identifying information received 315 by the online system 140 (i.e., Online System Cookie ID 678) matches at least some user-identifying information of the same type maintained 300 in the online system 140 for the user (i.e., Online System Cookie ID 678). Based on this determination, the online system 140 may add 330 the received 315 information to the information maintained 300 in the online system 140 for the user. In this example, the combined set of user-identifying information maintained 300 in the online system 140 for the user includes Partner Cookie ID 123, Partner Cookie ID 345, Partner User ID ABC, and Online System Cookie ID 678.

If user-identifying information received 315 by the online system 140 matches user-identifying information of the same type maintained 300 in the online system 140 for multiple online system users, the online system 140 may create a combined set of user-identifying information maintained 300 in the online system 140 for each user by adding 330 the received 315 information to the user-identifying information maintained 300 in the online system 140 for each user (e.g., in the user profile store 205). For example, if the online system 140 receives 315 an IP address associated with a client device 110 in conjunction with a cookie identifier that is unique to an individual in a partnering third-party system 130A, the online system 140 may compare 325 the IP address and the cookie identifier to IP addresses and cookie identifiers stored in the user profile store 205 for various online system users. In this example, if the cookie identifier does not match any cookie identifiers stored in the user profile store 205, but the IP address matches an IP address stored in the user profile store 205 in association with user profiles of two online system users, the online system 140 may store the cookie identifier in association with the user profiles of both of the online system users in the user profile store 205. In an alternative embodiment, the online system 140 may discard user-identifying information received 315 by the online system 140 that matches user-identifying information maintained 300 in the online system 140 for multiple online system users.

In various embodiments, if the online system 140 determines that user-identifying information received 315 by the online system 140 does not match user-identifying information maintained 300 in the online system 140 for any user of the online system 140, the online system 140 may store this unmatched user-identifying information (e.g., in the unmatched identity store 240). For example, suppose that the online system 140 receives 315 a cookie identifier in conjunction with an IP address, in which the cookie identifier is unique to an individual in a partnering third-party system 130A. In this example, if neither the cookie identifier nor the IP address matches a cookie identifier or an IP address included among user-identifying information maintained 300 in the online system 140 for an online system user, the online system 140 may store the cookie identifier in association with the IP address in the unmatched identity store 240. In alternative embodiments, if the online system 140 determines that user-identifying information received 315 by the online system 140 does not match user-identifying information maintained 300 in the online system 140 for a user of the online system 140, the online system 140 may discard the user-identifying information.

In embodiments in which the online system 140 stores unmatched user-identifying information, the online system 140 may later add 330 previously unmatched user-identifying information received at the online system 140 to user-identifying information maintained 300 in the online system 140 for a particular user. For example, if the online system 140 determines that a previously unmatched IP address matches an IP address maintained 300 in the online system 140 for a particular user of the online system 140, the online system 140 may create a combined set of user-identifying information for the user. In this example, the online system 140 may do so by adding 330 a cookie identifier stored in association with the previously unmatched IP address to user-identifying information maintained 300 in the online system 140 for the user.

Referring back to FIG. 3, upon creating a combined set of user-identifying information maintained 300 in the online system 140 for the user, the online system 140 may identify 335 (e.g., using the identity retention module 245) a subset of this user-identifying information that is maintained in the online system 140 and in the partnering third-party system 130A. For example, suppose that a combined set of user-identifying information for a user is created by adding 330 a cookie identifier and a username that are unique to the user in a partnering third-party system 130A to user-identifying information maintained 300 in the online system 140 for the user. In this example, the online system 140 may identify 335 the cookie identifier and the username as user-identifying information that is maintained in the online system 140 and in the partnering third-party system 130A for the same user since the cookie identifier and the username are unique to the user in the partnering third-party system 130A. In the above example, if the user-identifying information maintained 300 in the online system 140 for the user also includes a username that is unique to the user in the online system 140, the online system 140 may not identify 335 the username as user-identifying information that is maintained in the online system 140 and in the partnering third-party system 130A for the same user since it is maintained 300 only in the online system 140. As shown in FIG. 4, the online system 140 may identify 335 the user-identifying information maintained in the online system 140 and in the partnering third-party system 130A for the same online system user as Partner Cookie ID 123, Partner Cookie ID 345, and Partner User ID ABC.

The online system 140 may identify 335 user-identifying information maintained in the online system 140 and in the partnering third-party system 130A based on information stored in association with a user profile of the user (e.g., in the user profile store 205). For example, upon receiving a username from a partnering third-party system 130A that is unique to a user of the online system 140 in the partnering third-party system 130A, the online system 140 may store the username in the user profile store 205 in association with a user profile of the user, a date and a time that the username was received 315, and information indicating that the username was received 315 from the partnering third-party system 130A. In this example, the online system 140 subsequently may access the user profile store 205 and identify 335 the username as user-identifying information that is maintained in the online system 140 and in the partnering third-party system 130A based on the information indicating that the username was received 315 from the partnering third-party system 130A. As an additional example, suppose that the online system 140 receives 315 a cookie identifier from a partnering third-party system 130A that is associated with metadata indicating that the cookie identifier is unique to a user of the online system 140 in the partnering third-party system 130A. In this example, the online system 140 may store the cookie identifier in the user profile store 205 in association with a user profile of the user and the metadata indicating that the cookie identifier is unique to the user in the partnering third-party system 130A. Continuing with this example, the online system 140 subsequently may access the user profile store 205 and identify 335 the cookie identifier as user-identifying information that is maintained in the partnering third-party system 130A based on the metadata associated with the cookie identifier.

Referring again to FIG. 3, once the online system 140 has identified 335 a set of user-identifying information that is maintained in the online system 140 and in the partnering third-party system 130A for the same online system user, the online system 140 may act as an identity provider by communicating 340 information describing an association among this set of user-identifying information to the trusted third-party system 130B. The information describing the association among the set of user-identifying information may indicate that the information is associated with the same online system user. For example, information describing an association among a set of user-identifying information may indicate that a cookie identifier that is unique to an individual in a partnering third-party system 130A and a user identification number that is assigned by the partnering third-party system 130A are associated with the same online system user. As illustrated in FIG. 4, once the online system 140 has identified 335 the user-identifying information maintained in the online system 140 and in the partnering third-party system 130A for the same online system user (i.e., Partner Cookie ID 123, Partner Cookie ID 345, and Partner User ID ABC), the online system 140 may communicate 340 information describing an association among the user-identifying information to the trusted third-party system 130B.

Referring again to FIG. 3, the trusted third-party system 130B may compile 345 a report based at least in part on information describing an association among a set of user-identifying information for one or more online system users and information describing requests associated with content items 400 received 305 at various content publishers 130C from these users. The report may include various analytics that describe one or more performance metrics for one or more content items 400 presented to online system users by one or more content publishers 130C. Examples of performance metrics include impression performance metrics, revenue performance metrics, interaction performance metrics, etc. For example, the trusted third-party system 130B may compute impression performance metrics and revenue performance metrics for a content item 400 based on information describing impressions and conversions achieved by the content item 400 when presented to online system users by different content publishers 130C. In this example, the trusted third-party system 130B may then generate various analytics describing the performance metrics and compile 345 the analytics into a report.

In some embodiments, the trusted third-party system 130B may compile 345 the report by determining a sequence of events associated with one or more content items 400 based on information describing multiple requests associated with the content items 400 received 305 from the same online system user. For example, the trusted third-party system 130B may receive 320 information from a partnering third-party system 130A describing a request to present a content item 400 at a first content publisher 130C received 305 from an online system user associated with a first cookie identifier and a second request to access additional content associated with the same content item 400 subsequently received 305 at a second content publisher 130C from an online system user associated with a second cookie identifier. In this example, if information communicated 340 by the online system 140 indicates that the first cookie identifier and the second cookie identifier are associated with the same online system user, the trusted third-party system 130B may determine that the user requested to access additional content associated with the content item 400 at the second content publisher 130C after being presented with the content item 400 by the first content publisher 130C and compile 345 a report based on this determination.

As illustrated in FIG. 4, the trusted third-party system 130B may determine that a first sequence of events associated with the content item 400 that occurred on 7/5/17 at 12:45 P.M. associated with Partner Cookie ID 123 and that a second sequence of events associated with the same content item 400 that occurred on 7/6/17 at 10:06 A.M. associated with Partner Cookie ID 345 were performed by the same online system user. The trusted third-party system 130B may make this determination based on information describing an association among these cookie identifiers communicated 340 to the trusted third-party system 130B by the online system 140. In this example, the trusted third-party system 130B also may determine that the second sequence of events occurred after the first sequence of events based on the dates and times associated with each sequence of events. The trusted third-party system 130B may then compile 345 a report 415 based on these determinations.

In various embodiments, the report 415 may be compiled 345 by multiple trusted third-party systems 130B. For example, a first trusted third-party system 130B may determine a sequence of events associated with a content item 400 and then communicate information describing the sequence of events to a second trusted third-party system 130B. The second trusted third-party system 130B may then generate analytics associated with the content item 400 based on the sequence of events and compile 345 them into a report 415.

In some embodiments, the trusted third-party system 130B also may compile 345 the report 415 based on information received from identity providers other than the online system 140. In such embodiments, the trusted third-party system 130B may aggregate the information received from multiple identity providers prior to compiling 345 the report 415. For example, the trusted third-party-system 130B may receive information from a first identity provider indicating that a username that is unique to a user in a partnering third-party system 130A is associated with a client device identifier and information from a second identity provider indicating that a cookie identifier that is unique to a user in a partnering third-party system 130A is associated with the same client device identifier. In this example, the trusted third-party system 130B may aggregate the information received from the first and second identity providers, such that the username, the client device identifier, and the cookie identifier are associated with the same online system user. Continuing with this example, if the trusted third-party system 130B receives information describing requests associated with content items 400 received 305 from a user of the online system 140 associated with the username, the cookie identifier, and/or the client device identifier, the trusted third-party system 130B may determine that the requests are attributable to the same online system user and compile 345 a report 415 based on this determination.

In embodiments in which information describing associations among sets of user-identifying information is communicated 340 to the trusted third-party system 130B by multiple identity providers, the information communicated 340 to the trusted third-party system 130B may be inconsistent. For example, information from a first identity provider indicating that a cookie identifier that is unique to an online system user in a partnering third-party system 130A is associated with a client device identifier may be communicated 340 to the trusted third-party system 130B. In this example, information from a second identity provider indicating that the cookie identifier is associated with a different client device identifier also may be communicated 340 to the trusted third-party system 130B, such that information communicated 340 to the trusted third-party system 130B by the first and second identity providers are inconsistent.

In various embodiments, the trusted third-party system 130B may resolve inconsistencies among information describing associations among sets of user-identifying information provided by different identity providers by applying various rules. In some embodiments, a rule applied by the trusted third-party system 130B may be based on different priorities associated with different identity providers. For example, a rule may specify a ranking of different identity providers based on different priorities associated with the identity providers, such that if inconsistent information is provided to the trusted-third-party system 130B by different identity providers, the information provided by the highest ranked identity provider (i.e., the identity provider having the highest priority) is used to compile 345 a report 415. In embodiments in which different identity providers are associated with different priorities, inconsistencies among the information may be resolved dynamically depending on the identity providers that provided the inconsistent information. In some embodiments, rules applied by the trusted third-party system 130B to resolve inconsistencies among information received from different identity providers may be specified by a partnering third-party system 130A. For example, the trusted third-party system 130B may receive various rules from different partnering third-party systems 130A, such that if inconsistent information includes information describing associations among sets of user-identifying information that are maintained in a partnering third-party system 130A, the trusted third-party system 130B may apply one or more rules received from the partnering third-party system 130A to resolve the inconsistency.

The trusted third-party system 130B also may resolve inconsistencies among information provided by different identity providers by computing a score associated with information provided by each identity provider. The score associated with information provided by an identity provider may be computed by the trusted third-party system 130B based on a model maintained in a partnering third-party system 130A. For example, a model maintained in a partnering third-party system 130A may specify a weight associated with information provided by an identity provider based on a priority associated with the identity provider, the type of information provided, a time that the information was provided, etc. Based on the score associated with the information provided by each identity provider, the trusted third-party system 130B may resolve inconsistencies among the information (e.g., by using information associated with the highest scores to compile 345 a report 415).

Referring once more to FIG. 3, the report 415 compiled 345 by the trusted third-party system 130B may be communicated 350, 355 by the trusted third-party system 130B to a partnering third-party system 130A, to a content publisher 130C, or to a content provider (e.g., an advertiser). For example, if the trusted third-party system 130B compiles 345 a report 415 based on user-identifying information that is maintained in a partnering third-party system 130A, the trusted third-party system 130B may communicate 350 the report 415 to the partnering third-party system 130A. In this example, if the report 415 compiled 345 by the trusted third-party system 130B includes various analytics for a content item 400, the report 415 also may be communicated to a content provider associated with the content item 400. Additionally, in this example, if the report 415 includes analytics describing the presentation of the content item 400 by a content publisher 130C, the report 415 also may be communicated 355 to the content publisher 130C by the partnering third-party system 130A or by the trusted third-party system 130B. As shown in the example of FIG. 4, once the trusted third-party system 130B has compiled 345 the report 415, the trusted third-party system 130B may communicate 350 the report 415 to the partnering third-party system 130A.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining, in an online system, a set of user-identifying information for a user of the online system, wherein a subset of the maintained set of user-identifying information for the user also is maintained in a partnering third-party system that has established a partnership with the online system;
responsive to receiving a request associated with a content item from the user of the online system at a content publisher, receiving, at the online system, an additional set of user-identifying information for the user, wherein at least a subset of the received additional set of user-identifying information for the user is maintained in the partnering third-party system;
comparing the received additional set of user-identifying information for the user to the maintained set of user-identifying information for the user;
responsive to determining at least some of the received additional set of user-identifying information for the user matches at least some of the maintained set of user-identifying information for the user, adding the received additional set of user-identifying information for the user to the maintained set of user-identifying information for the user as a combined set of user-identifying information maintained in the online system for the user;
identifying a subset of the combined set of user-identifying information that also is maintained in the partnering third-party system; and
communicating information describing an association among user-identifying information included in the subset of the combined set of user-identifying information to a trusted third-party system.

2. The method of claim 1, further comprising:
receiving the subset of the maintained set of user-identifying information for the user that also is maintained in the partnering third-party system from the partnering third-party system.

3. The method of claim 1, wherein the content publisher is the online system.

4. The method of claim 1, wherein the request associated with the content item received from the user of the online system comprises a request to present the content item to the user or a request to perform an action associated with the content item.

5. The method of claim 1, further comprising:
receiving information describing the request associated with the content item and a time associated with the request associated with the content item; and
communicating the information describing the request associated with the content item and the time associated with the request associated with the content item to the trusted third-party system.

6. The method of claim 5, wherein the information describing the request associated with the content item is associated with a performance metric.

7. The method of claim 1, wherein one or more of the maintained set of user-identifying information and the received additional set of user-identifying information comprise personally identifiable information for the user.

8. The method of claim 7, wherein the personally identifiable information comprises one or more of: a client device identifier, a user identifier, a cookie identifier, and a browser identifier.

9. The method of claim 1, wherein the received additional set of user-identifying information for the user is received via one or more of: a tag added to the content item by the partnering third-party system and a cookie stored in a client device associated with the user of the online system.

10. The method of claim 9, wherein the cookie is stored in the client device associated with the user of the online system by the online system.

11. The method of claim 9, wherein the cookie is stored in the client device associated with the user of the online system by the partnering third-party system.

12. The method of claim 1, wherein a subset of the received additional set of user-identifying information for the user is obfuscated.

13. A computer program product comprising a computer readable storage medium having instructions encoded thereon that, when executed by a processor, cause the processor to:
maintain, in an online system, a set of user-identifying information for a user of the online system, wherein a subset of the maintained set of user-identifying information for the user also is maintained in a partnering third-party system that has established a partnership with the online system;
responsive to receiving a request associated with a content item from the user of the online system at a content publisher, receive, at the online system, an additional set of user-identifying information for the user, wherein at least a subset of the received additional set of user-identifying information for the user is maintained in the partnering third-party system;
compare the received additional set of user-identifying information for the user to the maintained set of user-identifying information for the user;
responsive to determining at least some of the received additional set of user-identifying information for the user matches at least some of the maintained set of user-identifying information for the user, add the received additional set of user-identifying information for the user to the maintained set of user-identifying information for the user as a combined set of user-identifying information maintained in the online system;
identify a subset of the combined set of user-identifying information that also is maintained in the partnering third-party system; and
communicate information describing an association among user-identifying information included in the subset of the combined set of user-identifying information to a trusted third-party system.

14. The computer program product of claim 13, wherein the computer readable storage medium further has instructions encoded thereon that, when executed by the processor, cause the processor to:
receive the subset of the maintained set of user-identifying information for the user that also is maintained in the partnering third-party system from the partnering third-party system.

15. The computer program product of claim 13, wherein the content publisher is the online system.

16. The computer program product of claim 13, wherein the request associated with the content item received from the user of the online system comprises a request to present the content item to the user or a request to perform an action associated with the content item.

17. The computer program product of claim 13, wherein the computer readable storage medium further has instructions encoded thereon that, when executed by the processor, cause the processor to:
receive information describing the request associated with the content item and a time associated with the request associated with the content item; and
communicate the information describing the request associated with the content item and the time associated with the request associated with the content item to the trusted third-party system.

18. The computer program product of claim 17, wherein the information describing the request associated with the content item is associated with a performance metric.

19. The computer program product of claim 13, wherein one or more of the maintained set of user-identifying information and the received additional set of user-identifying information comprise personally identifiable information for the user.

20. The computer program product of claim 19, wherein the personally identifiable information comprises one or more of: a client device identifier, a user identifier, a cookie identifier, and a browser identifier.

21. The computer program product of claim 13, wherein the received additional set of user-identifying information for the user is received via one or more of: a tag added to the content item by the partnering third-party system and a cookie stored in a client device associated with the user of the online system.

22. The computer program product of claim 21, wherein the cookie is stored in the client device associated with the user of the online system by the online system.

23. The computer program product of claim 21, wherein the cookie is stored in the client device associated with the user of the online system by the partnering third-party system.

24. The computer program product of claim 13, wherein a subset of the received additional set of user-identifying information for the user is obfuscated.

25. A method comprising:
receiving, at an online system, a set of user-identifying information for a user of the online system, wherein a subset of the received set of user-identifying information for the user is maintained in a partnering third-party system that has established a partnership with the online system;
comparing the received set of user-identifying information for the user to an additional set of user-identifying information maintained in the online system for the user;
responsive to determining at least some of the received set of user-identifying information for the user matches at least some of the maintained additional set of user-identifying information for the user, adding the received set of user-identifying information for the user to the maintained additional set of user-identifying information for the user as a combined set of user-identifying information maintained in the online system for the user;
identifying a subset of the combined set of user-identifying information that also is maintained in the partnering third-party system; and
communicating information describing an association among user-identifying information included in the subset of the combined set of user-identifying information to a trusted third-party system.
